(19) United States
(12) Patent Application Publication
(10) Pub. No.: US 2010/0026324 A1
(43) Pub. Date: Feb. 4, 2010

(54) SOIL MOISTURE SENSOR WITH LONG BATTERY LIFE

(76) Inventor: Hans Camenzind, San Francisco, CA (US)

Correspondence Address: CHEIN-HWA S. TSAO, 6684 MT PAKRON DRIVE, SAN JOSE, CA, 95120, US

(21) Appl. No.: 12/185,748

(22) Filed: Aug. 4, 2008

(51) Int. Cl. G01N 27/04

(52) U.S. Cl. 324/696

(57) ABSTRACT

A power-efficient soil moisture sensor includes:
A moisture sensing element.
An alarm device.
Sensor circuitry for measuring soil moisture and activating the alarm device when soil moisture reaches a threshold.
A powered control timer. The control timer powers the sensor circuitry with a low duty cycle, defined as T_{ON}/T_{OFF} with T_{ON}/T_{OFF}<<1, hence saving an average consumed power.
The alarm device can be an LED and the moisture sensing element is of resistive type. The sensor circuitry drives the moisture sensing element with AC voltages to measure soil moisture while avoiding electrolysis and corrosion at the moisture sensing element. As the measured soil moisture approaches a threshold the sensor circuitry flashes the LED with a gradually increasing intensity. The alarm device can also be an audible speaker (SPK). As the measured soil moisture approaches a threshold, the sensor circuitry pulses the SPK with a gradually increasing volume.

### CROSS REFERENCE TO RELATED APPLICATIONS

### FIELD OF INVENTION

This invention relates generally to the field of agricultural technology. More specifically, the present invention is directed to the electronic measurement of soil moisture content.

### BACKGROUND OF THE INVENTION

Generally two methods have been used to measure the soil moisture content: capacitive and resistive. Examples of the capacitive method are described in U.S. Pat. No. 3,771,548 to Rauchwerger, U.S. Pat. No. 4,657,039 to Bireley et al, U.S. Pat. No. 4,683,904 to Iltis, U.S. Pat. No. 4,850,386 to Bireley, U.S. Pat. No. 5,424,649 to Gluck at al, U.S. Pat. No. 5,445,178 to Feuer, and U.S. Pat. No. 7,170,302 to Lee. All of these inventions tend to use complex circuitry and high frequencies which result in, when they are battery powered, an undesirable short battery life.

The resistive sensing method is less complex. Examples are U.S. Pat. No. 2,437,134 to Smith, U.S. Pat. No. 3,979,667 to Cornes, and U.S. Pat. No. 4,122,389 to Haagen, all of which apply direct current (DC) voltage to a moisture sensing probe. However, in U.S. Pat. No. 4,514,722 to Batchelor et al a square-wave voltage of alternating polarity is applied instead to avoid corrosion and electrolysis at the sensing probe. Another example of using voltage with alternating polarity is U.S. Pat. No. 4,796,654 to Simpson, which uses 60 Hz alternating current (AC) plus graphite coated sensing probes that further reduce corrosion.

As all of these inventions of capacitive or resistive measurement continuously measure the soil moisture content, their measurement circuitry continuously consumes a corresponding amount of power that tends to drain the battery.

### SUMMARY OF THE INVENTION

A power-efficient electronic soil moisture sensor is disclosed. The soil moisture sensor includes:
A moisture sensing element for sensing the soil moisture.
An alarm device.
A sensor circuitry coupled to the moisture sensing element and the alarm device. When powered, the measures the soil moisture and activates the alarm device when the soil moisture level meets a pre-determined criterion.
A powered control timer coupled to the sensor circuitry. The control timer applies power to the sensor circuitry with a low duty cycle hence saving average power consumed by the soil moisture sensor. The duty cycle is characterized by a power-on time T_{ON} and power-off time T_{OFF} with duty cycle=T_{ON}/T_{OFF} and T_{ON}/T_{OFF}<<1.

In an embodiment the alarm device is a light-emitting diode (LED) for visually alerting a user. T_{ON} is from about 2 milliseconds to about 100 milliseconds while T_{OFF} is from about 1 second to about 60 seconds. Furthermore, as the measured soil moisture approaches a predetermined level the sensor circuitry flashes the LED with a gradually increasing intensity.

In a more specific embodiment, the moisture sensing element is of resistive type in that its resistance is a function of its moisture content. The sensor circuitry, while being powered by a DC voltage, drives the moisture sensing element with voltages of alternating polarity to measure the soil moisture while avoiding electrolysis and corrosion at the moisture sensing element.

In an even more specific embodiment, the sensor circuitry further includes:
a) An H-Bridge containing the moisture sensing element and four driver transistors.
b) A parallel RC-network serially connected to the H-Bridge.
c) An oscillator with differential voltage outputs controlling the driver transistors so as to develop a quasi-DC voltage across the RC-network that is a function of the moisture sensing element resistance.
d) A comparator with its inputs respectively connected to the quasi-DC voltage and a pre-determined threshold voltage and with its output switchably powering the LED.

In an alternative embodiment, the alarm device is an audible speaker (SPK) for audibly alerting a user. T_{ON} is from about 20 milliseconds to about 500 milliseconds while T_{OFF} is from about 1 second to about 60 seconds. Furthermore, as the measured soil moisture approaches a predetermined level, the sensor circuitry pulses the SPK with a gradually increasing volume.

In yet another alternative embodiment, the moisture sensing element is of capacitive type in that its dielectric constant is a function of its moisture content.

These aspects of the present invention and their numerous embodiments are further made apparent, in the remainder of the present description, to those of ordinary skill in the art.

### BRIEF DESCRIPTION OF THE DRAWINGS

In order to more fully describe numerous embodiments of the present invention, reference is made to the accompanying drawings. However, these drawings are not to be considered limitations in the scope of the invention, but are merely illustrative.

FIG. 1 is a functional block diagram illustrating the power-efficient electronic soil moisture sensor circuitry of the present invention; and

FIG. 2A through FIG. 2C depict selected key voltage and current waveforms produced by the soil moisture sensor circuitry.

### DETAILED DESCRIPTION OF SPECIFIC EMBODIMENTS

The description above and below plus the drawings contained herein merely focus on one or more currently preferred embodiments of the present invention and also describe some exemplary optional features and/or alternative embodiments. The description and drawings are presented for the purpose of illustration and, as such, are not limitations of the present invention. Thus, those of ordinary skill in the art would readily recognize variations, modifications, and alternatives. Such variations, modifications and alternatives should be understood to be also within the scope of the present invention.

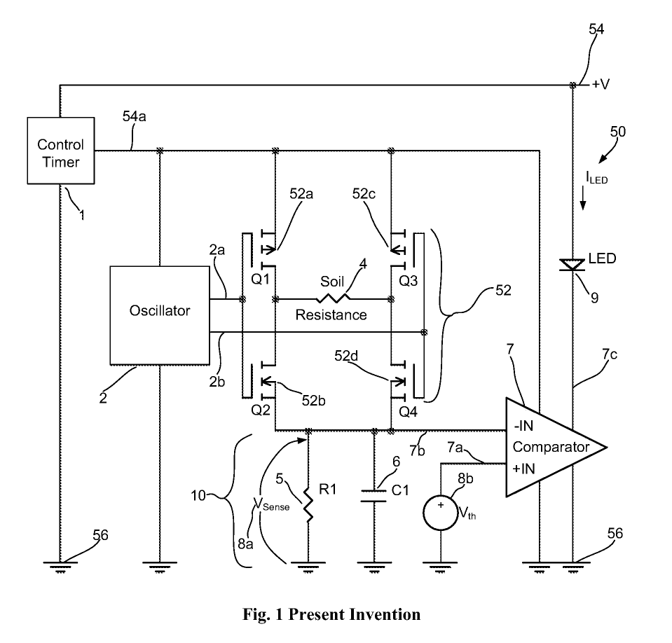

FIG. 1 is a functional block diagram illustrating the power-efficient electronic soil moisture sensor 50 of the present invention. In this embodiment, the power-efficient electronic soil moisture sensor 50 uses a resistive moisture sensing element 4 with its resistance being a function of its moisture content. In a typical application, the resistive moisture sensing element 4 is embedded in a soil that is the subject of moisture sensing. The whole power-efficient electronic soil moisture sensor 50 circuitry is ultimately powered by a voltage source +V 54, for example a battery. A powered control timer 1 connects, via switched voltage supply 54a, the remaining circuitry of the power-efficient electronic soil moisture sensor 50 to the voltage source +V 54 for a brief power-on time, called T_{ON}, to sense soil moisture via the resistance value of the resistive moisture sensing element 4. Should the measured soil moisture level reach a pre-determined threshold, to be presently described, the power-efficient electronic soil moisture sensor 50 would activate an LED 9 to visually alert a user. In an embodiment, T_{ON} is selected to be just long enough for the human eyes to see a blinking LED, about 5 msec (millisecond). More generally, a T_{ON} ranges from about 2 msec to about 100 msec would work satisfactorily as well. Afterwards, no voltage is applied by the powered control timer 1 to the remaining circuitry for a power-off time T_{OFF}. The following parameter:

duty cycle=T_{ON}/T_{OFF}

is thus defined by T_{ON} and T_{OFF}. For saving the average power consumed by the electronic soil moisture sensor 50, the following condition:

T_{ON}/T_{OFF}<<1

is set to realize a low duty cycle. In an embodiment, T_{OFF} is selected to be about 2 seconds. More generally, a T_{OFF} ranges from about 1 second to about 60 seconds would work satisfactorily as well. While T_{OFF} should be set as long as possible to save the average power, an excessively long T_{OFF} would render the power-efficient electronic soil moisture sensor 50 ineffective in that, even if the user stays nearby, the visual retention of a blinking LED with excessively low duty cycle would diminish.

Continuing with the description of the soil moisture sensor circuitry, during T_{ON} an oscillator 2 produces differential voltage outputs 2a and 2b which are two square waves of opposite polarities. The frequency of the oscillator 2 is chosen so that there are sufficient number of cycles contained within T_{ON}. In an embodiment, the oscillator frequency is selected to be about 15 kHz. More generally, an oscillator frequency ranges from about 5 kHz to about 100 kHz would work satisfactorily as well. The differential voltage outputs are applied to an H-Bridge 52. The H-Bridge 52 has the resistive moisture sensing element 4 plus four driver field effect transistors (FET) Q1 52a, Q2 52b, Q3 52c, Q4 52d. During a first state of the two square waves driver FET Q1 52a and driver FET Q4 52d are turned on and the soil embedding the resistive moisture sensing element 4 is connected to the voltage source +V 54 with one polarity. However, during a second state of the two square waves driver FET Q2 52b and driver FET Q3 52c are turned on and the soil embedding the resistive moisture sensing element 4 is connected to the voltage source +V 54 with an opposite polarity. Therefore, while being powered by a DC voltage source +V 54 through the powered control timer 1, the soil moisture sensor circuitry actually drives the resistive moisture sensing element 4 with voltages of alternating polarity to measure the soil moisture thus avoiding electrolysis and corrosion at the resistive moisture sensing element 4.

Serially connected to the H-Bridge 52 is a parallel RC-network 10 with a resistor R1 5 and a capacitor C1 6. The parallel RC-network 10 is grounded at a ground 56 that is the common ground of the soil moisture sensor circuitry. Thus, during both the first state and the second state of the two square waves a resulting current flows through the resistor R1 5. Furthermore, independent of the polarity of connection at the soil, the current through resistor R1 5 always flows in the same direction, i.e., it is a rectified pseudo DC current. The capacitor C1 6 is connected across the resistor R1 5 to smooth out any voltage glitches resulting from the two rapidly switching square waves at the soil. Thus, as time continues during the power-on time interval T_{ON}, a quasi-DC sense voltage Vsense 8a is developed across the parallel RC-network 10 that is a function of the moisture sensing element 4 resistance. Furthermore, the quasi-DC sense voltage Vsense 8a rises slowly and only reaches its full level after a time determined by the RC-time constant of the parallel RC-network 10.

The sense voltage Vsense 8a is applied to one comparator input −IN 7b of a comparator 7 with its other comparator input +IN 7a biased at a predetermined threshold voltage Vth 8b. Thus, as long as the sense voltage Vsense 8a remains lower than the threshold voltage Vth 8b, the comparator 7 activates the LED 9 by pulling, via comparator output 7c, a current I_{LED} through it. However, as soon as the sense voltage Vsense 8a exceeds the threshold voltage Vth 8b the LED 9 gets turned off. Therefore, in the present invention the soil moisture measurement only takes place during the short time interval T_{ON} thereby reducing its average current consumption and increasing battery life. During T_{ON} the power-efficient electronic soil moisture sensor 50 circuit determines if the soil moisture level is above or below a predetermined threshold level and consequently if the LED 9 should stay off or be turned on for the remainder of T_{ON}. The LED 9 thus flashes with full intensity if the soil moisture level has dropped below the predetermined threshold level, but only flashes with reduced intensity as the predetermined threshold level is approached.

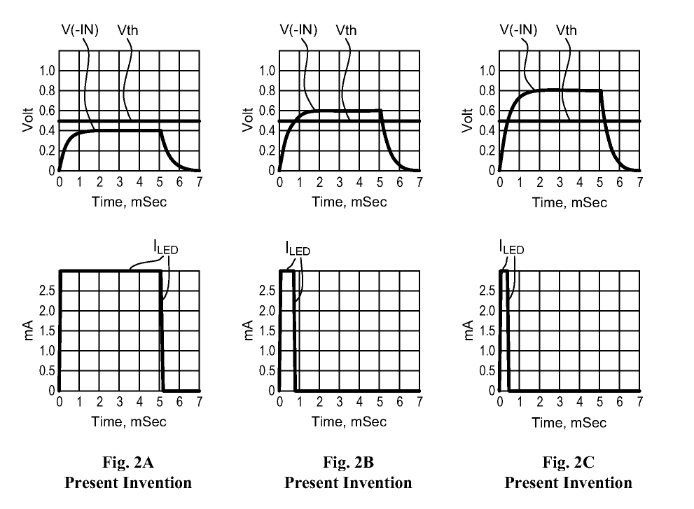

FIG. 2A through FIG. 2C depict sense voltage Vsense 8a and I_{LED} waveforms produced by the power-efficient electronic soil moisture sensor 50 circuitry with T_{ON} =5 msec and the threshold voltage Vth 8b set at an example voltage of 0.5 Volts. In FIG. 2A a soil resistance only causes the sense voltage Vsense 8a to reach 0.4 Volts, indicating that the soil moisture level is below its desired level. Correspondingly, the resulting LED current I_{LED} stays on (at about 3 mA) during almost the entire interval T_{ON}. In FIG. 2B the sense voltage Vsense 8a now reaches 0.6 Volts, indicating that the soil moisture level is just above its desired level. Correspondingly, the LED 9 is turned on during only a fraction of the interval T_{ON} thus it blinks only dimly. In FIG. 2C the sense voltage Vsense 8a now reaches 0.8 Volts, indicating that the soil moisture level is well above its desired level. Correspondingly, the LED 9 is turned on for only a minute fraction of the interval T_{ON} thus it stays very dim.

While the description above contains many specificities, these specificities should not be constructed as accordingly limiting the scope of the present invention but as merely providing illustrations of numerous presently preferred embodiments of this invention. For example, to those skilled in the art, the driver FETs Q1 52a, Q2 52b, Q3 52c, Q4 52d of the H-Bridge 52 can be replaced with bipolar transistors. For another example, resistor R1 5, capacitor C1 6, comparator 7 and threshold voltage Vth 8b can be inverted thus referenced to the switched voltage supply 54a instead. As a third example, the LED 9 can be replaced with an audible speaker (SPK) for audibly alerting the user. With an SPK as the alarm device, T_{ON} can be set from about 20 milliseconds to about 500 milliseconds and T_{OFF} can be correspondingly set from about 1 second to about 60 seconds. Thus, as the measured soil moisture approaches a predetermined level, the moisture sensor circuitry would then pulse the SPK with a gradually increasing volume. As a fourth example, the resistive moisture sensing element 4 can instead be replaced with a capacitive type sensor in that its dielectric constant hence capacitance is a function of its moisture content. In this case, other than the voltage source +V 54, the powered control timer 1 and the LED 9, the rest of the soil moisture sensor circuitry should also be replaced with a matching capacitance-sensing circuit as well.

Throughout the description and drawings, numerous exemplary embodiments were given with reference to specific configurations. It will be appreciated by those of ordinary skill in the art that the present invention can be embodied in numerous other specific forms and those of ordinary skill in the art would be able to practice such other embodiments without undue experimentation. The scope of the present invention, for the purpose of the present patent document, is hence not limited merely to the specific exemplary embodiments of the foregoing description, but rather is indicated by the following claims. Any and all modifications that come within the meaning and range of equivalents within the claims are intended to be considered as being embraced within the spirit and scope of the present invention.

What is claimed are:

1. A power-efficient electronic soil moisture sensor comprising:
a moisture sensing element for sensing the soil moisture;
an alarm device;
a sensor circuitry coupled to the moisture sensing element and the alarm device;
said sensor circuitry, when powered, further measures the soil moisture and activates the alarm device when the soil moisture level meets a pre-determined criterion; and
a powered control timer, coupled to the sensor circuitry, that applies power to the sensor circuitry with a low duty cycle
whereby saving average power consumed by the soil moisture sensor.

2. The soil moisture sensor of claim 1 wherein said duty cycle is further characterized by a power-on time T_{ON} and power-off time T_{OFF} with duty cycle=T_{ON}/T_{OFF} and T_{ON}/T_{OFF}<<1.

3. The soil moisture sensor of claim 2 wherein said alarm device is a light-emitting diode (LED) for visually alerting a user, T_{ON} is from about 2 milliseconds to about 100 milliseconds and T_{OFF} is from about 1 second to about 60 seconds.

4. The soil moisture sensor of claim 3 wherein, as the measured soil moisture approaches a predetermined level, said sensor circuitry further flashes the LED with a gradually increasing intensity.

5. The soil moisture sensor of claim 4 wherein the moisture sensing element is of resistive type in that its resistance is a function of its moisture content.

6. The soil moisture sensor of claim 5 wherein the sensor circuitry, while being powered by a direct current (DC) voltage, drives the resistive type moisture sensing element with voltages of alternating polarity to measure the soil moisture while avoiding electrolysis and corrosion at the moisture sensing element.

7. The soil moisture sensor of claim 6 wherein the sensor circuitry further comprises:
a) an H-Bridge containing the moisture sensing element and four driver transistors;
b) a parallel RC-network serially connected to the H-Bridge;
c) an oscillator with differential voltage outputs controlling the driver transistors so as to develop a quasi-DC voltage across the RC-network that is a function of the moisture sensing element resistance; and
d) a comparator with its inputs respectively connected to the quasi-DC voltage from the RC-network and a pre-determined threshold voltage and with its output switchably powering the LED.

8. The soil moisture sensor of claim 7 wherein the oscillator differential voltage outputs are two square waves of opposite polarities with frequency from about 5 kHz to about 100 kHz.

9. The soil moisture sensor of claim 2 wherein said alarm device is an audible speaker (SPK) for audibly alerting a user, T_{ON} is from about 20 milliseconds to about 500 milliseconds and T_{OFF} is from about 1 second to about 60 seconds.

10. The soil moisture sensor of claim 9 wherein, as the measured soil moisture approaches a predetermined level, said sensor circuitry further pulses the SPK with a gradually increasing volume.

11. The soil moisture sensor of claim 1 wherein the moisture sensing element is of capacitive type in that its capacitance is a function of its moisture content.

12. The soil moisture sensor of claim 11 wherein the moisture sensing element has a dielectric constant that is a function of its moisture content.
